(19) United States
(12) Patent Application Publication
(10) Pub. No.: US 2025/0189298 A1
(43) Pub. Date: Jun. 12, 2025

(54) MEASUREMENT DEVICE

(71) Applicant: Panasonic Intellectual Property Management Co., Ltd., Osaka (JP)

(72) Inventors: Katsuya NOZAWA, Osaka (JP); Tatayuki Kiyohara, Osaka (JP)

(21) Appl. No.: 18/971,965

(22) Filed: Dec. 6, 2024

(30) Foreign Application Priority Data
Dec. 12, 2023 (JP) 2023-209159

(51) Int. Cl. G01B 9/02; G01B 9/02015; G01B 11/24

(52) U.S. Cl. CPC G01B 9/02049; G01B 9/02029; G01B 11/2441

(57) ABSTRACT

A measurement device includes: a first movable body including a reflector; a second movable body including a light emission point, a light entry point, and an optical system; a driving mechanism that adjusts a position of the second movable body; a controller that controls the driving mechanism; and at least one optical fiber. Light emitted from the light emission point is emitted onto the reflector via the optical system, and reflected light that is the light reflected from the reflector enters the light entry point. The controller causes the driving mechanism to adjust the position of the second movable body, based on an intensity of the reflected light that has entered the light entry point. The light emission point or the light entry point is an end of the at least one optical fiber.

### CROSS REFERENCE TO RELATED APPLICATION

The present application is based on and claims priority of Japanese Patent Application No. 2023-209159 filed on Dec. 12, 2023. The entire disclosure of the above-identified application, including the specification, drawings and claims is incorporated herein by reference in its entirety.

### FIELD

The present disclosure relates to a measurement device.

### BACKGROUND

Contact-type three-dimensional shape measuring instruments are used for measuring the shapes of lenses and the like with high accuracy. Patent Literature (PTL) 1 discloses the configuration of an optical probe used in a contact-type three-dimensional shape measuring instrument.

### CITATION LIST

### Patent Literature

PTL 1: Japanese Patent No. 3000819

### SUMMARY

### Technical Problem

The present disclosure provides a measurement device that includes a small, lightweight movable body.

### Solution to Problem

A measurement device according to one aspect of the present disclosure includes: a first movable body including a reflector; a second movable body including a light emission point, a light entry point, and an optical system; a driving mechanism that adjusts a position of the second movable body; a controller that controls the driving mechanism; and at least one optical fiber, in which light emitted from the light emission point is emitted onto the reflector via the optical system, reflected light that is the light reflected from the reflector enters the light entry point, the controller causes the driving mechanism to adjust the position of the second movable body, based on an intensity of the reflected light that has entered the light entry point, and the light emission point or the light entry point is an end of the at least one optical fiber.

### Advantageous Effects

The present disclosure enables providing a measurement device that includes a small, lightweight movable body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an outline configuration of a measurement device according to Embodiment 1.

FIG. 2 illustrates an outline configuration of a measurement device according to Embodiment 2.

FIG. 3 illustrates an outline configuration of a measurement device according to Embodiment 3.

FIG. 4 illustrates an outline configuration of a measurement device according to Embodiment 4.

FIG. 5 illustrates the concept of a bundled fiber.

FIG. 6 illustrates an outline configuration of a conventional three-dimensional shape measuring instrument.

### DESCRIPTION OF EMBODIMENTS

### Overview of Present Disclosure

The present inventors have found that the following problems occur regarding the optical probe used in the three-dimensional shape measuring instrument disclosed in PTL 1. Below, the problems of the conventional optical probe are described with reference to the configuration of the optical probe disclosed in PTL 1.

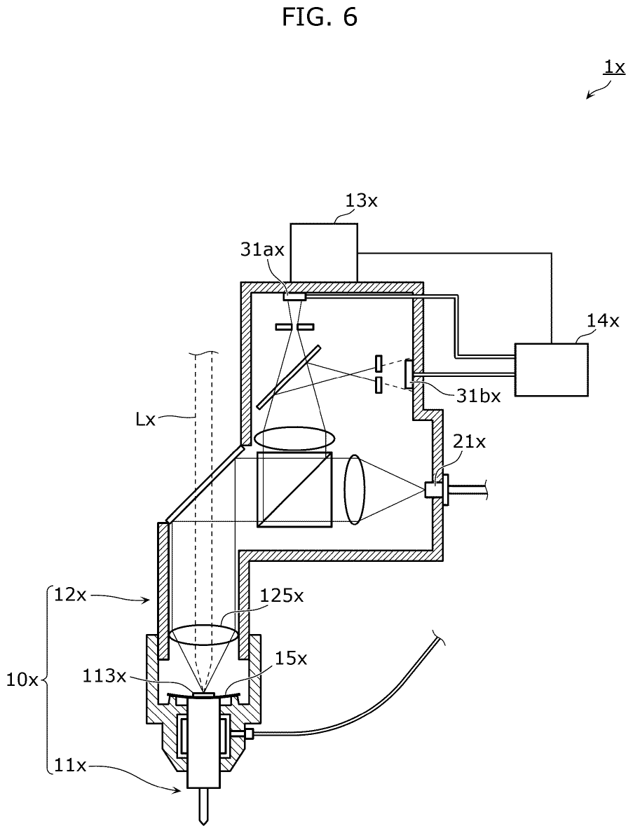

FIG. 6 illustrates an outline configuration of the conventional three-dimensional shape measuring instrument. As illustrated in FIG. 6, three-dimensional shape measuring instrument 1x includes optical probe 10x. Optical probe 10x is composed of the two elements of movable component 11x and movable component 12x.

Movable component 11x moves up and down following the shape of a measurement target (not shown). Three-dimensional shape measuring instrument 1x emits light Lx (shown in FIG. 6 as a broken line) onto movable component 11x from outside of optical probe 10x, and the position of movable component 11x is determined based on the reflected light. Three-dimensional shape measuring instrument 1x thus obtains shape information regarding the measurement target.

Movable component 12x has the function of restricting the motion of movable component 11x to the up-down direction. Further, movable component 11x and movable component 12x are coupled by means of spring 15x. In order to maintain contact strength between movable component 12x and the measurement target within a certain range, the relative positions of movable component 11x and movable component 12x must be made to fall within a certain range.

Moreover, in the configuration of PTL 1, object lens 125x is disposed on movable component 12x. Object lens 125x condenses light that has entered from outside of optical probe 10x to mirror 113x in movable component 11x. Object lens 125x transmits the reflected light from mirror 113x to a laser measuring instrument (not shown) outside of optical probe 10x. In order for the reflected light to return to the laser measuring instrument, mirror 113x of movable component 11x must be positioned near the focal position of object lens 125x of movable component 12x. In this sense as well, optical probe 10x necessitates making the relative positions of movable component 11x and movable component 12x fall within a certain range.

Movable component 12x includes semiconductor laser 21x and light detectors 31ax and 31bx as means for measuring the relative positions of movable component 11x and movable component 12x. The reason for movable component 12x including the two light detectors 31ax and 31bx is that each of detectors 31ax and 31bx has a different dependence on the relative positions of movable component 11x and movable component 12x. Due to this configuration, in a case of deviation from the desired relative positions, it is possible to calculate in which direction and to what extent to move movable component 12x in order to reach the desired relative positions.

As illustrated in FIG. 6, the contact-type three-dimensional shape measuring instrument includes driving means 13x and relative position measuring means 14x.

Relative position measuring means 14x calculates the relative positions of movable component 11x and movable component 12x based on the output of each of light detectors 31ax and 31bx. Driving means 13x adjusts the relative positions of movable component 11x and movable component 12x by changing the position of movable component 12x such that certain relative positions are reached.

The three-dimensional shape measuring instrument changes the relative positions of optical probe 10x and the measurement target in the lateral direction in order to measure the three-dimensional shape of the measurement target. In this case, the position of movable component 11x in the up-down direction changes in accordance with the shape of the measurement target. Each time the relative positions in the lateral direction are changed, the relative positions must be measured and the position of movable component 12x must be changed in order to reach certain relative positions between movable component 11x and movable component 12x.

However, if the speed of changing the position of movable component 12x is slow, this limits the speed of the shape measurement. Further, if the positional change falls behind, the relative positions of movable component 11x and movable component 12x deviate from the suitable range. In this case, problems such as the following occur: movable component 11x is excessively pressed against by the measurement target, or movable component 11x moves away from the measurement target and measurement cannot be performed as normal.

The weight of movable component 12x affects the speed of changing the position of movable component 12x. In order to increase the speed of changing the position, there is a need to make movable component 12x as lightweight as possible. Moreover, in order to inhibit the measurement target and movable component 12x from physically interfering with each other, there is a need for movable component 12x to be as small as possible.

Thus, the present disclosure has the object of providing a measurement device that includes a small, lightweight movable body.

A measurement device according to a first aspect of the present disclosure includes: a first movable body including a reflector; a second movable body including a light emission point, a light entry point, and an optical system; a driving mechanism that adjusts a position of the second movable body; a controller that controls the driving mechanism; and at least one optical fiber, in which light emitted from the light emission point is emitted onto the reflector via the optical system, reflected light that is the light reflected from the reflector enters the light entry point, the controller causes the driving mechanism to adjust the position of the second movable body, based on an intensity of the reflected light that has entered the light entry point, and the light emission point or the light entry point is an end of the at least one optical fiber.

Since the light emission point or the light entry point is the end of the at least one optical fiber, the second movable body can be reduced in size and weight. This is because typically, the size of the end of the optical fiber is smaller than that of a semiconductor laser or a light detector, which makes it possible to contribute to reducing the size and weight of the second movable body. Furthermore, in the case of providing an element such as a semiconductor laser, a light detector, or the like, a power line for supplying power to operate the element and a signal line for extracting a signal outputted from the element become necessary. In contrast, using the optical fiber obviates the need to provide a power line or a signal line, and makes it possible to reduce the total number of cables connected to the second movable body. In this sense as well, it is possible to realize the size reduction and weight reduction of the second movable body.

A measurement device according to a second aspect of the present disclosure is the measurement device according to the first aspect, in which when the measurement device measures a target, the first movable body comes in contact with the target.

In a case of the contact-type measurement device measuring the measurement target, the distance between the second movable body and the measurement target lessens as well. Thus, due to the size reduction of the second movable body, it becomes easier to prevent contact between the second movable body and the measurement target.

A measurement device according to a third aspect of the present disclosure is the measurement device according to the first aspect or the second aspect, including an elastic body that couples the first movable body with the second movable body.

This facilitates maintaining the relative positions of the first movable body and the second movable body within the certain range. Furthermore, in the case of the contact-type measurement device, force of the first movable body pushing against the measurement target can be applied by means of the elastic body. The first movable body can be inhibited from moving away from the measurement target, thereby allowing for enhancement of the measurement accuracy.

A measurement device according to a fourth aspect of the present disclosure is the measurement device according to any one of the first aspect to the third aspect, in which the at least one optical fiber includes a first optical fiber, the light emission point is a first end of the first optical fiber, the second movable body includes: a beam splitter that splits the reflected light into first reflected light and second reflected light; a first light-shielding member including a first pinhole that the first reflected light enters; and a second light-shielding member including a second pinhole that the second reflected light enters, the second movable body includes a plurality of light entry points each being the light entry point, and each of the first pinhole and the second pinhole is the light entry point.

This makes it unnecessary to provide the second movable body with a light source that also acts as a heat source, such as a laser element or the like. This allows for inhibiting a rise in temperature of the second movable body, which makes it possible to inhibit changes in the refractive index of the air inside the second movable body. Thus, changes in the optical path length of the light used for measuring the measurement target can be inhibited, making it possible to inhibit deterioration of the measurement accuracy.

A measurement device according to a fifth aspect of the present disclosure is the measurement device according to any one of the first aspect to the third aspect, in which the second movable body includes: a laser element including the light emission point; and a beam splitter that splits the reflected light into first reflected light and second reflected light, the at least one optical fiber includes: a second optical fiber including a second end that the first reflected light enters; and a third optical fiber including a third end that the second reflected light enters, the second movable body includes a plurality of light entry points each being the light entry point, and each of the second end and the third end is the light entry point.

This makes it possible to connect two optical fibers to the second movable body instead of providing a light detector and a member having a pinhole that serves as the light entry point, whereby the second movable body can be reduced in size and weight.

A measurement device according to a sixth aspect of the present disclosure is the measurement device according to any one of the first aspect to the third aspect, in which the second movable body includes a beam splitter that splits the reflected light into first reflected light and second reflected light, the at least one optical fiber includes: a first optical fiber; a second optical fiber including a second end that the first reflected light enters; and a third optical fiber including a third end that the second reflected light enters, the light emission point is a first end of the first optical fiber, the second movable body includes a plurality of light entry points each being the light entry point, and each of the second end and the third end is the light entry point.

This makes it possible to reduce the size and weight of the second movable body. Furthermore, it is also possible to inhibit deterioration of the measurement accuracy due to the generation of heat.

A measurement device according to a seventh aspect of the present disclosure is the measurement device according to any one of the first aspect to the sixth aspect, in which the at least one optical fiber includes a multi-core fiber including a plurality of cores, the second movable body includes a plurality of light entry points each being the light entry point, and individual ends of the plurality of cores are each the light entry point.

The total number of optical fibers fixed to the second movable body can thus be reduced, making it possible to reduce the size and weight of the second movable body.

A measurement device according to an eighth aspect of the present disclosure is the measurement device according to any one of the first aspect to the seventh aspect, in which the at least one optical fiber is a single-mode fiber.

The light entry point or the light emission point can thus be reduced in size, making it possible to further reduce the size of the second movable body.

A measurement device according to a ninth aspect of the present disclosure is the measurement device according to any one of the first aspect to the seventh aspect, in which the at least one optical fiber is a multi-mode fiber.

This makes it easier to make light enter the optical fiber.

A measurement device according to a tenth aspect of the present disclosure is the measurement device according to any one of the first aspect to the ninth aspect, in which the optical system includes a graded-index lens that is fixed to the end of the at least one optical fiber.

This makes it possible to reduce the size and weight of the optical system, thereby allowing for reducing the size and weight of the second movable body.

A measurement device according to an eleventh aspect of the present disclosure is the measurement device according to the first aspect or the tenth aspect, in which the at least one optical fiber includes a multi-core fiber including a plurality of cores, and an end of one of the plurality of cores is the light entry point and the light emission point.

This makes it possible to employ only one multi-core fiber as the optical fiber to be connected to the second movable body. Thus, this allows for contributing to reducing the size of the second movable body.

A measurement device according to a twelfth aspect of the present disclosure is the measurement device according to the fourth aspect or the sixth aspect, including: a laser element, in which light emitted from the laser element enters from an end of the first optical fiber on a side opposite to the first end, is guided along the first optical fiber, and is emitted from the first end.

This makes it possible to provide a laser element separately from the second movable body, thereby facilitating replacement when the laser element has deteriorated. This makes it possible to inhibit degradation of the accuracy of measuring the measurement target resulting from the influence of heat generated by the laser element during light radiation.

A measurement device according to a thirteenth aspect of the present disclosure is the measurement device according to any one of the first aspect to the twelfth aspect, including: a light intensity measurer that measures an intensity of the reflected light that has entered the light entry point.

This makes it possible to provide a light intensity measurer separately from the second movable body, thereby facilitating replacement when the light intensity measurer has deteriorated.

Hereinafter, certain exemplary embodiments are described in greater detail with reference to the accompanying Drawings.

Each of the exemplary embodiments described below shows a general or specific example. The numerical values, shapes, materials, elements, the arrangement and connection of the elements, steps, the processing order of the steps etc. shown in the following exemplary embodiments are mere examples, and therefore do not limit the scope of the appended Claims and their equivalents. Therefore, among the elements in the following exemplary embodiments, those not recited in any one of the independent claims are described as optional elements.

Furthermore, each Drawing is merely a schematic illustration for the purpose of conceptual explanation, and is not intended to indicate the actual size, shape, and/or the like. Therefore, for example, the scales and the like in the Drawings do not necessarily match. Moreover, in the Drawings, the same reference symbols are appended to elements that are substantially the same, and overlapping descriptions are omitted or simplified.

Furthermore, in the present specification, the light emission point is a part at which light is emitted into the second movable body, and is a part having a certain area. For example, the light emission point is an end of the optical fiber, the light emission face of a light-radiating element, or the like. The light entry point is a part at which light transmitted along the interior of the second movable body enters the light detector, and is a part having a certain area. For example, the light entry point is an end of the optical fiber, a pinhole, or the like.

Furthermore, in the present specification, the “up-down direction” means the direction in which the relative positions of the first movable body and the second movable body can be changed. Specifically, the direction parallel to the axis of a stylus included in the first movable body is the up-down direction. The tip direction along the axis of the stylus is the “downward direction”, and the direction opposite to that is the “upward direction”. The tip of the stylus comes in contact with the measurement target.

Moreover, in the present specification, unless otherwise specified particularly, ordinals such as “first”, “second”, and the like do not indicate the number or order of elements, but are used for the purpose of distinguishing between elements of the same type to avoid confusion.

### Embodiment 1

First, a measurement device according to Embodiment 1 is described. The measurement device according to the present embodiment has a configuration in which, instead of a laser light source provided to a movable component, an end of the optical fiber connected to the light source is connected to the movable component.

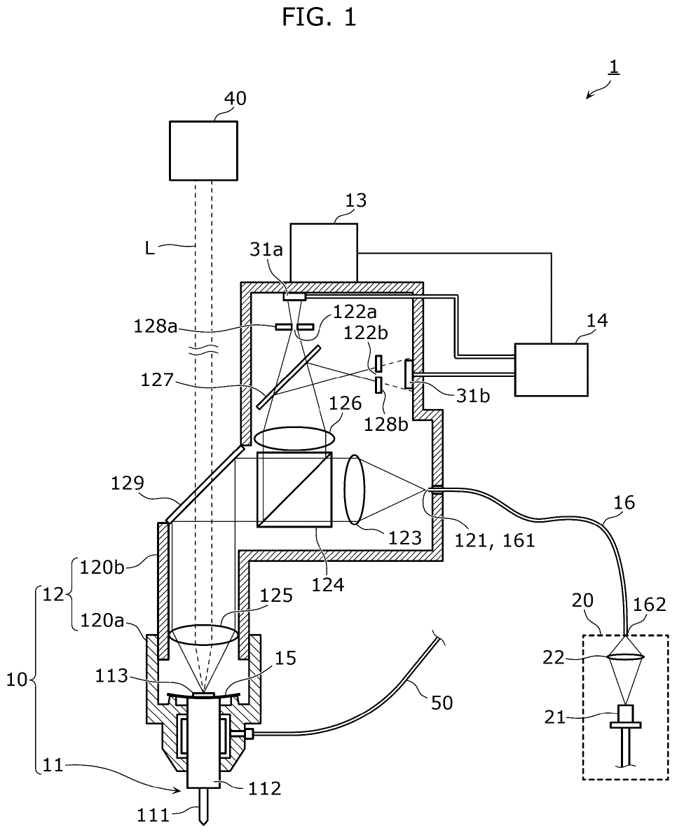

Hereinafter, the specific configuration of the measurement device according to the present embodiment is described using FIG. 1. FIG. 1 illustrates an outline configuration of the measurement device according to the present embodiment.

Measurement device 1 according to the present embodiment is a three-dimensional shape measuring instrument. Specifically, measurement device 1 measures the surface shape of a measurement target (not shown). As illustrated in FIG. 1, measurement device 1 includes probe 10, driving mechanism 13, controller 14, spring 15, and optical fiber 16. Furthermore, measurement device 1 includes light source component 20, light detectors 31a and 31b, interferometer 40, and air supplier 50.

### Probe

Probe 10 includes movable component 11 and movable component 12. Movable component 11 is an example of the first movable body that has the reflector. Movable component 12 is an example of the second movable body that has the light emission point, the light entry point, and the optical system.

Movable component 11 has stylus 111, sliding component 112, and mirror 113. Stylus 111 is fixed to sliding component 112. When measuring the measurement target, the tip of stylus 111 comes in contact with the measurement target. In the case in which stylus 111 has come in contact with the measurement target, the position of movable component 11 changes in the up-down direction in accordance with the shape of the measurement target. Sliding component 112 restricts the movement of movable component 11 to the up-down direction. Mirror 113 is an example of the reflector included in the first movable body. The mutual positional relationship between stylus 111, sliding component 112, and mirror 113 is fixed.

Movable component 12 includes guide mechanism 120a and probe housing 120b. The mutual positional relationship between guide mechanism 120a and probe housing 120b is fixed. In the present embodiment, movable component 12 has light emission point 121 and light entry points 122a and 122b. Light emission point 121 is end 161 of optical fiber 16. Light entry point 122a is a first pinhole that is included in light-shielding member 128a. Light entry point 122b is a second pinhole that is included in light-shielding member 128b. Furthermore, light detectors 31a and 31b are provided to movable component 12. Moreover, movable component 12 has the optical system fixed on probe housing 120b.

The optical system includes: collimator lens 123; condenser lens 125 on the mirror 113 side; and condenser lens 126 on the light detector 31a and 31b side. Furthermore, the optical system includes optical elements 124 and 129 and beam splitter 127.

Collimator lens 123 converts light emitted from light emission point 121 into nearly parallel light (hereinafter, referred to as parallel light). Nearly parallel light means light having a smaller divergence angle than that of light before being incident on collimator lens 123, i.e., in the present embodiment, light emitted from end 161 of optical fiber 16.

Condenser lens 125 condenses incident light to the region of mirror 113. For example, condenser lens 125 condenses parallel light, which has passed through collimator lens 123 and optical element 124 and been reflected by optical element 129, to the region of mirror 113. Furthermore, condenser lens 125 converts light reflected by mirror 113 into parallel light and makes this parallel light incident on condenser lens 126 via optical elements 129 and 124. Moreover, in the present embodiment, condenser lens 125 condenses light L, used for measurement of the measurement target, to the region of mirror 113. Furthermore, condenser lens 125 converts light L reflected by mirror 113 into parallel light and makes this light enter interferometer 40 via optical element 129.

Condenser lens 126 condenses incident light, and makes the incident light enter light entry points 122a and 122b.

Optical element 124 separates: light traveling from light emission point 121, being end 161 of optical fiber 16, toward condenser lens 125; and light traveling from condenser lens 125 toward condenser lens 126 (light reflected by mirror 113). Optical element 124 is, for example, a polarizing beam splitter. The polarizing beam splitter is an optical element having a dielectric multilayer film. The polarizing beam splitter reflects light components that have electric fields parallel to the dielectric multilayer film, and permits the passage of light components that have electric fields perpendicular to the dielectric multilayer film.

For example, light that exits from collimator lens 123 is a component that passes through the dielectric multilayer film. This allows light that exits from collimator lens 123 to pass through optical element 124 and travel toward the condenser lens 125 side.

Furthermore, arranging a λ/4 wavelength plate in the optical path between optical element 124, being the polarizing beam splitter, and condenser lens 125 allows for passage through the λ/4 wavelength plate twice: when light travels from optical element 124 toward condenser lens 125, and when light travels from condenser lens 125 toward optical element 124. Appropriately setting the angle of the λ/4 wavelength plate makes 90-degree rotation possible, between the electric field direction of light traveling from optical element 124 toward the condenser lens 125 side, and the electric field direction of light coming from the condenser lens 125 side to enter optical element 124. By thus rotating the electric field direction, optical element 124 can direct light that has come from the condenser lens 125 side toward the condenser lens 126 side. A polarizer or an element that controls the electric field direction, such as a λ/2 wavelength plate or the like, may be placed between collimator lens 123 and optical element 124. Alternatively, a polarization-holding fiber may be employed as optical fiber 16, and the direction of end 161 of optical fiber 16 may be adopted as a predetermined direction to control the direction of the electric field of the light that exits from collimator lens 123.

Optical element 124 may be an element other than a polarization beam splitter. For example, a beam splitter not dependent upon polarization may be employed as optical element 124. For example, in the case of optical element 124 being a beam splitter having a splitting ratio of 50:50, ½ of the light that has exited from collimator lens 123 and entered optical element 124 travels toward the condenser lens 125 side, and ½ of the light that has come from condenser lens 125 and entered optical element 124 travels toward the condenser lens 126 side. In other words, about ¼ of the light that has passed through collimator lens 123 travels toward the condenser lens 126 side. Compared to the configuration in which the polarizing beam splitter is used, this configuration involves the loss of light intensity; however, simplification of the configuration is made possible. Note that the splitting ratio of the beam splitter is not limited to being 50:50, and may be 10:90, 30:70, or another splitting ratio.

Optical element 129 is an optical element that has the purpose of overlapping the optical paths of light L, which is used for measurement by interferometer 40, and light for measuring the relative positions of movable component 11 and movable component 12, and making these incident on mirror 113. Furthermore, with respect to reflected light that has been reflected from mirror 113 and passed through condenser lens 125, optical element 129 separates reflected light for entry into interferometer 40, and reflected light for measuring the relative positions of movable component 11 and movable component 12. Optical element 129 is, for example, a dichroic mirror, but may be a half mirror, a beam splitter cube, a polarizing beam splitter cube, or the like.

For example, when the wavelength of light L, which is used by interferometer 40, and the wavelength of the light for measuring the relative positions of movable component 11 and movable component 12 are made different, the paths of both lights can be brought together or nearly completely separated by an optical element having wavelength dependence, such as a dichroic mirror or the like. In the configuration of FIG. 1, a dichroic mirror is used as optical element 129. The dichroic mirror allows the passage of light L, which is used by interferometer 40, and reflects the light for measuring the relative positions of movable component 11 and movable component 12.

Alternatively, when the polarization of light L, which is used by interferometer 40, and the polarization of the light for measuring the relative positions of movable component 11 and movable component 12 are made different, the paths of both lights can be brought together or nearly completely separated by an optical element having polarization dependence, such as a polarizing beam splitter cube. Furthermore, there may be a case in which a non-polarizing beam splitter is used for overlapping the optical paths of the light used by interferometer 40, and the light for measuring the relative positions of movable component 11 and movable component 12. In this case, an optical element that allows one light to pass through and shields the other light, such as a notch filter, a bandpass filter, a long pass filter, a short pass filter, or the like, may be provided in the optical path where separating these lights is desired.

Beam splitter 127 splits light that has come from condenser lens 125 and passed through condenser lens 126 into two beams. Specifically, beam splitter 127 splits reflected light reflected from mirror 113 into first reflected light and second reflected light. More specifically, beam splitter 127 splits the reflected light by intensity into the first reflected light and the second reflected light, and emits each of these in a different direction. The ratio of the intensity splitting by beam splitter 127 is, for example, 1 to 1, but is not limited thereto.

In the present embodiment, the optical system included in movable component 12 may include, apart from collimator lens 123 and condenser lenses 125 and 126, an optical element having optical power.

Movable component 12 has: light-shielding member 128a having a first pinhole that is positioned in the optical path of the first reflected light split by beam splitter 127; and light-shielding member 128b having a second pinhole located in the optical path of the second reflected light. The first reflected light enters the first pinhole included in light-shielding member 128a, i.e., light entry point 122a. The second reflected light enters the second pinhole included in light-shielding member 128b, i.e., light entry point 122b. The first pinhole, which serves as light entry point 122a, and the second pinhole, which serves as light entry point 122b, differ in terms of the distance from the principal point of condenser lens 126.

The relative position of movable component 12 with respect to movable component 11 is variable. Guide mechanism 120a of movable component 12 restricts the movement of movable component 11 to the up-down direction. Air supplier 50 is connected to movable component 11. The movement of movable component 11 can be performed smoothly due to the air supplied from air supplier 50.

In the present embodiment, movable component 11 and movable component 12 are coupled to each other by means of spring 15. Spring 15 is an example of the elastic body included in measurement device 1. Spring 15 applies force to movable component 11 in the direction that movable component 11 is pressed against the measurement target (specifically the downward direction). Consequently, contact between stylus 111 and the measurement target is more easily secured, which allows for enhancing measurement reliability.

Measurement device 1 may include rubber, being another example of the elastic body, instead of spring 15. Furthermore, measurement device 1 may not include the elastic body. For example, movable component 11 and movable component 12 may be coupled to each other by means of a mechanism that utilizes a magnet or the like.

### Driving Mechanism

Driving mechanism 13 adjusts the position of movable component 12. Specifically, driving mechanism 13 receives a control signal from controller 14 and changes the position of movable component 12. Driving mechanism 13 is, for example, a linear motor or the like, but is not particularly limited as long as it is capable of adjusting the position of movable component 12.

### Controller

Controller 14 controls driving mechanism 13. Controller 14 is a control signal emitter that generates a control signal that is output to driving mechanism 13.

Specifically, controller 14 causes driving mechanism 13 to adjust the position of movable component 12, based on the intensity of the reflected light that has entered the light entry point. More specifically, controller 14 calculates the relative positions of movable component 11 and movable component 12 based on the output signals from light detectors 31a and 31b. Controller 14 calculates the distance and direction to move movable component 12 in order to bring the thus calculated relative positions within the specified range. Further, controller 14 sends driving mechanism 13 a control signal for moving movable component 12 in the calculated direction, by the calculated distance. The method for calculating the relative positions of movable component 11 and movable component 12 is described later.

### Optical Fiber

Optical fiber 16 is an example of the first optical fiber, and has end 161 and end 162.

End 161 is an example of the first end, and is light emission point 121 included in movable component 12. End 161 is fixed, either directly or via another component, to probe housing 120b, which is an element of probe 10.

End 162 is the end of optical fiber 16 on the side opposite to end 161. End 162 is not fixed to probe housing 120b. End 162 is connected to light source component 20, and light from light source component 20 enters thereinto. Light emitted from light source component 20 enters from end 162 of optical fiber 16, and is guided along optical fiber 16 and emitted from end 161.

Note that optical fiber 16 may be a fiber laser in which the optical fiber itself emits light. Alternatively, optical fiber 16 may, as in a fluorescent fiber or a nonlinear optical fiber, have a wavelength-converting function. In this case, optical fiber 16 may emit only light after wavelength conversion, or may emit both light prior to wavelength conversion and light after wavelength conversion. Optical fiber 16 and light source component 20 may thus be a unified body.

Optical fiber 16 may be a single-mode fiber, or may be a multi-mode fiber. In the case of optical fiber 16 being a single-mode fiber, light emission point 121 can be reduced in size. When light emission point 121 is reduced in size, it is possible to create an optical path with low divergence by means of the optical system included in movable component 12. This facilitates building a system in which changes in the quantity of light of light detectors 31a and 31b are sensitive to changes in the relative positions of movable component 11 and movable component 12. The case of optical fiber 16 being the multi-mode fiber has the advantage of light emitted by light source component 20 easily entering end 162 of optical fiber 16. Thus, this is advantageous from the viewpoint of the signal-to-noise ratio.

### Light Source Component

Light source component 20 emits light that is detectable by light detectors 31a and 31b. The wavelength of the light emitted by light source component 20 is not particularly limited, and as long as the wavelength is made to differ from that of the light used by interferometer 40, the separation of these lights by optical element 129, which is a dichroic mirror or the like, is easily performed.

As illustrated in FIG. 1, light source component 20 includes laser element 21 and optical system 22. Laser element 21 is, for example, a semiconductor laser. Laser element 21 is a light source with a small light radiation point; thus, the light can be easily made to enter end 162 of optical fiber 16. Optical system 22 is an optical element for making light that has been emitted from laser element 21 enter end 162 of optical fiber 16. Note that light source component 20 may not include optical system 22.

### Light Detectors

Light detector 31a is an example of the light intensity measurer that measures the intensity of the first reflected light that has entered light entry point 122a. Light detector 31b is an example of the light intensity measurer that measures the intensity of the second reflected light that has entered light entry point 122b. Light detectors 31a and 31b are each, for example, a photoelectric transducer such as a photodiode, a phototransistor, or the like.

Light detector 31a detects light that has passed through the first pinhole, i.e., the first reflected light that has entered light entry point 122a. Light detector 31a measures the intensity of the first reflected light that has been detected, and outputs to controller 14 a signal corresponding to the measured intensity. Light detector 31b detects light that has passed through the second pinhole, i.e., the second reflected light that has entered light entry point 122b. Light detector 31b measures the intensity of the second reflected light that has been detected, and outputs to controller 14 a signal corresponding to the measured intensity.

### Interferometer

Interferometer 40 uses light L to measure the position of mirror 113, which is included in movable component 11 of probe 10. The relative position of mirror 113 is fixed with respect to stylus 111.

The position of stylus 111, which comes in contact with the measurement target, changes in line with the shape of the measurement target; thus, by measuring the position of mirror 113, it is possible to measure the shape of the measurement target.

Interferometer 40 uses, for example, a wavelength-stabilized He—Ne laser or a frequency-stabilized semiconductor laser as the light source of light L, which is used for measurement. Note that probe 10 may separately include each of a mirror for reflecting light L for interferometer 40, and a mirror for reflecting light for measuring the relative positions of movable component 11 and movable component 12.

### Method for Controlling Relative Positions of Movable Component 11 and Movable Component 12

Next, a method for controlling the relative positions of movable component 11 and movable component 12 is described.

After entering optical fiber 16 from end 162 and being guided along optical fiber 16, the light emitted from light source component 20 is emitted from end 161, which serves as light emission point 121.

The light emitted from light emission point 121 is converted by collimator lens 123 into nearly parallel light (hereinafter, referred to as parallel light) and transmitted within probe housing 120b. Specifically, the parallel light from collimator lens 123 passes through optical element 124, and is then reflected by optical element 129 and enters condenser lens 125.

By means of condenser lens 125, the parallel light is converted into light that is condensed to the region of mirror 113 and reflected by mirror 113. The light reflected by mirror 113 once again passes through condenser lens 125 and becomes light that is nearly parallel (hereinafter, referred to as reflected light). The reflected light is transmitted within probe housing 120b, the orientation of the reflected light is changed by optical element 124 to a direction different from the direction of entry, and the reflected light then becomes incident on condenser lens 126. The reflected light is converted into condensed light by condenser lens 126.

The condensed light is split by beam splitter 127 into the two lights of first reflected light and second reflected light. Here, the first pinhole included in light-shielding member 128a and the second pinhole included in light-shielding member 128b are disposed in the optical paths of each of the first reflected light and the second reflected light. The intensity of the light that has passed through each of the pinholes is measured by means of light detectors 31a and 31b, which are arranged behind each of the first pinhole and the second pinhole.

The distance from the principal point of condenser lens 126 to the first pinhole, which serves as light entry point 122a, is different from the distance from the principal point of condenser lens 126 to the second pinhole, which serves as light entry point 122b. The quantity of light that passes through the pinholes, i.e., the quantity of light that enters the light entry points, is dependent upon the distance between the light condensing position of condenser lens 126 and the positions of the pinholes (i.e., the light entry points). Specifically, the pinholes (i.e., the light entry points) being present in a position closer to the light condensing position of condenser lens 126 results in a greater quantity of light passing through.

The light condensing position of condenser lens 126 is dependent upon the relative positions of condenser lens 125 on the mirror 113 side, and mirror 113. Thus, for example, controller 14 sends, to driving mechanism 13, the control signal for moving movable component 12 such that the intensity of the light measured at light detector 31a is constantly at the maximum. Consequently, the relative positions of movable component 11 and movable component 12 can be kept constant by adjusting the position of movable component 12. Alternatively, controller 14 may adjust the relative position of movable component 12 via driving mechanism 13 such that the difference between the intensity of the light measured by light detector 31a and the intensity of the light measured by light detector 31b is 0.

### Effects

Next, the effects of measurement device 1 according to the present embodiment are described while presenting a comparison to conventional optical probe 10x, illustrated in FIG. 6.

Specifically, in the conventional example, light from semiconductor laser 21x, which is fixed to movable component 12x, is used for measurement of the relative positions of movable component 11x and movable component 12x. In contrast, in measurement device 1, light emitted from end 161 of optical fiber 16 is used. The advantages resulting from such a configuration are explained below.

The first advantage is the reduction in size and weight of movable component 12.

In order to inhibit deterioration resulting from ambient air and the like, semiconductor laser 21x is typically contained inside a package that has a metal housing with a size of about several mm, and a glass window. On the other hand, end 162 of optical fiber 16, which serves as light emission point 121, does not necessitate a metal housing or a glass window. Thus, movable component 12 can be reduced in weight by omitting these.

Furthermore, with regard to the size as well, in the case of optical fiber 16, the diameter of end 161 thereof can be made 1 mm or less. Thus, utilizing end 162 of optical fiber 16, instead of semiconductor laser 21x, as light emission point 121 makes it possible to reduce the size of movable component 12.

Furthermore, optical fiber 16 radiates light from a round cross section that is highly symmetrical and small in diameter. In particular, a single-mode fiber has an especially small cross section. Thus, optical fiber 16 makes it possible to radiate light having uniform spatial modes. Therefore, the light radiated from optical fiber 16 can be inhibited from divergence even if a small, lightweight lens having a short focal length is used as collimator lens 123 for conversion into collimated light having a small diameter.

The ability to reduce the diameter of the light makes it possible to reduce in size each of components such as the lens, prism, mirror, and the like included in the optical system fixed to movable component 12. This consequently makes it possible to reduce the size and weight of the optical system as a whole, which allows for contribution to reducing the size of movable component 12.

Furthermore, the optical system included in movable component 12 may include a GRIN (Graded-Index: refractive index distribution-type) lens fixed to end 161 of optical fiber 16. Using a GRIN lens allows for omitting collimator lens 123, making it possible to further reduce the size and weight of movable component 12.

Light that has uniform spatial modes can be condensed within a smaller range. This means that pinholes having smaller hole diameters can be used as the pinholes for detecting the relative positions of movable component 11 and movable component 12. Alternatively, this means that the focal length of the lenses that condense the light toward the pinholes can be reduced in size. Consequently, these also contribute to reducing the size and weight of movable component 12.

On the other hand, semiconductor laser 21x, which is the conventional light source, has spatial broadening and radiates light that is asymmetrical in the up-down direction and the left-right direction. Thus, the collimated light, which is small in diameter, is susceptible to divergence, and it is difficult to reduce the size of the optical system that includes the lens and the like.

The second advantage is the reduction of wires.

Operating semiconductor laser 21x requires connection to a power source using different wires for each of the anode and the cathode. In other words, it is necessary to connect a minimum of two wires to semiconductor laser 21x, which is fixed to movable component 12x. In the case of also using an output monitor attached inside a typical semiconductor laser 21x, one further wire is necessary. As the wires connected to movable component 12x become more numerous, reducing the size of movable component 12x becomes more difficult.

In contrast, in the present embodiment, light source component 20 is provided separately from movable component 12. It is only necessary to connect one optical fiber 16 to movable component 12 for light emission. Thus, movable component 12 can be reduced in size.

The third advantage is the reduction of heat generation.

With semiconductor laser 21x, generally less than half of the power consumed is converted into light. The remainder of the power is released as heat. The waste heat from semiconductor laser 21x, which is fixed to movable component 12x, causes a rise in temperature inside movable component 12x. The rise in temperature inside movable component 12x causes the refractive index of the internal air to fluctuate and consequently causes what is referred to as flickering. Light L, the distance measurement mechanism for the shape measurement of the measurement target, also passes through the interior of movable component 12x; thus, this flickering negatively affects the accuracy of the shape measurement of the measurement target.

Conversely, in the present embodiment, light source component 20, the principal source of heat generation, is not provided to movable component 12. With optical fiber 16, which is connected to movable component 12, heat generation of the components fixed to movable component 12 can be largely ignored. Thus, the effect of heat can be greatly reduced, making it possible to inhibit deterioration of the accuracy of measuring the measurement target.

The fourth advantage is ease of replacement.

Semiconductor laser 21x generally has a lifespan of about 10,000 hours. This lifespan equates to about one year in the case of continuous lighting. When semiconductor laser 21x deteriorates, it becomes difficult to measure the relative positions of movable component 11x and movable component 12x; consequently, it becomes necessary to replace semiconductor laser 21x.

In the case in which semiconductor laser 21x is fixed to movable component 12x, it is necessary, each time a replacement is made, to perform adjustment work on the optical system attached to movable component 12x. Since the optical system of movable component 12x is partially shared with interferometer 40, which is for the shape measurement of the measurement target, attentive care must be given for this adjustment.

Meanwhile, in the present embodiment, laser element 21 is disposed separately from movable component 12. In this case, even when replacing laser element 21, adjustment is only necessary for the optical system coupled to optical fiber 16. Thus, replacement adjustment work can be made easier.

### Embodiment 2

Next, a measurement device according to Embodiment 2 is described. The measurement device according to the present embodiment has a configuration in which, instead of a light detector provided to a movable component, an end of the optical fiber connected to the light detector is connected to the movable component.

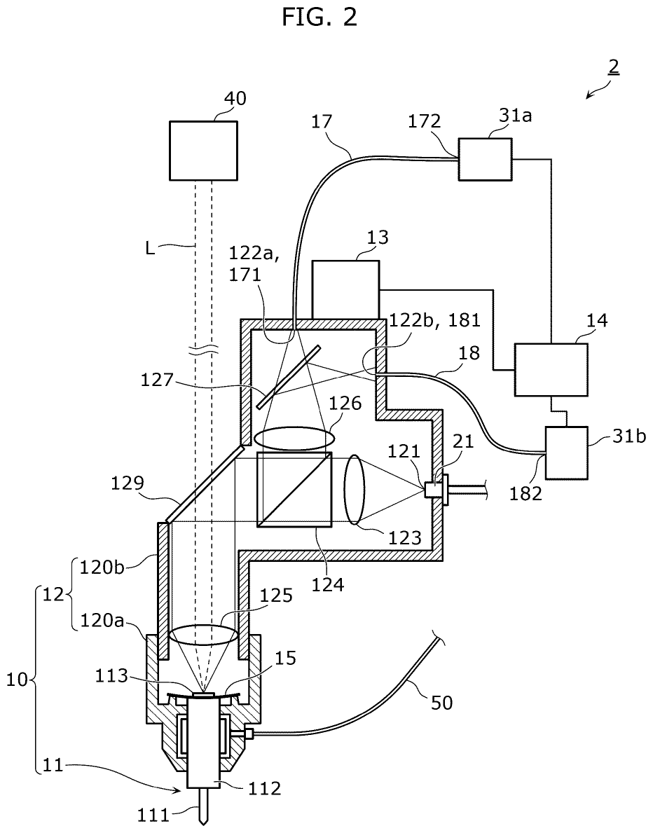

Hereinafter, the specific configuration of the measurement device according to the present embodiment is described with reference to FIG. 2. FIG. 2 illustrates an outline configuration of the measurement device according to the present embodiment. Note that hereinafter, detailed explanation of the components shared with Embodiment 1 is omitted or simplified, and the description focuses on the points of difference with Embodiment 1.

As illustrated in FIG. 2, measurement device 2 according to the present embodiment includes probe 10, driving mechanism 13, controller 14, spring 15, and optical fibers 17 and 18. Furthermore, measurement device 2 includes laser element 21, light detectors 31a and 31b, and interferometer 40.

### Probe

Probe 10 includes movable component 11 and movable component 12. The configuration of movable component 11 is the same as in Embodiment 1; thus, explanation thereof is omitted.

Movable component 12 includes guide mechanism 120a and probe housing 120b. The configurations of guide mechanism 120a and probe housing 120b are the same as in Embodiment 1. Note that in accordance with, e.g., the elements provided to movable component 12 and the cable(s) connected, the shapes and sizes of guide mechanism 120a and probe housing 120b may be changed as appropriate.

Furthermore, movable component 12 has light emission point 121 and light entry points 122a and 122b. In the present embodiment, the specific configurations of each of light emission point 121 and light entry points 122a and 122b are different from those in Embodiment 1. Specifically, light emission point 121 is a laser emission face of laser element 21. Light entry point 122a is end 171 of optical fiber 17. Light entry point 122b is end 181 of optical fiber 18.

Movable component 12 has an optical system fixed to probe housing 120b. The optical system is the same as that in Embodiment 1. Specifically, the optical system includes collimator lens 123, optical element 124, condenser lens 125, condenser lens 126, beam splitter 127, and optical element 129. In the present embodiment, movable component 12 is not provided with light-shielding members 128a and 128b.

### Optical Fiber

Optical fiber 17 is an example of the second optical fiber, and has end 171 and end 172.

End 171 is an example of the second end, and is light entry point 122a, which the first reflected light enters. End 171 is fixed to probe housing 120b either directly or via another component.

End 172 is the end of optical fiber 17 on the side opposite to end 171. End 172 is not fixed to probe housing 120b. End 172 is, for example, connected to light detector 31a. End 172 emits the first reflected light, which has entered from end 171 and been guided along optical fiber 17, to light detector 31a.

Optical fiber 18 is an example of the third optical fiber, and has end 181 and end 182.

End 181 is an example of the third end, and is light entry point 122b, which the second reflected light enters. End 181 is fixed to probe housing 120b either directly or via another component.

End 182 is the end of optical fiber 18 on the side opposite to end 181. End 182 is not fixed to probe housing 120b. End 182 is, for example, connected to light detector 31b. End 182 emits the second reflected light, which has entered from end 181 and been guided along optical fiber 18, to light detector 31b.

Optical fibers 17 and 18 may each be a single-mode fiber or a multi-mode fiber. In order to obtain a sufficient quantity of light, the multi-mode fiber is advantageous.

Furthermore, a polarization-maintaining fiber may be used for each of optical fibers 17 and 18. When the polarization-maintaining fiber is used, it is easy to use a polarizing optical element to separate the light used by interferometer 40 and the light used for measuring the relative positions of movable component 11 and movable component 12.

In movable component 12, end 171 of optical fiber 17 is disposed in the optical path of the first reflected light, which has been split by beam splitter 127. Furthermore, end 181 of optical fiber 18 is disposed in the optical path of the second reflected light, which has been split by beam splitter 127. End 171 (light entry point 122a) of optical fiber 17 and end 181 (light entry point 122b) of optical fiber 18 differ in terms of the distance from the principal point of condenser lens 126.

### Laser Element

Laser element 21 is fixed to movable component 12. Laser element 21 includes light emission point 121. Specifically, the light-radiating face of laser element 21 is light emission point 121. Laser element 21 is, for example, a semiconductor laser.

### Light Detectors

Light detector 31a is an example of the light intensity measurer that measures the intensity of the first reflected light that has entered light entry point 122a. Light detector 31b is an example of the light intensity measurer that measures the intensity of the second reflected light that has entered light entry point 122b. Light detectors 31a and 31b are each, for example, a photoelectric transducer such as a photodiode, a phototransistor, or the like.

In the present embodiment, light detector 31a measures the intensity of the first reflected light, which has entered from end 171, been guided along optical fiber 17, and been emitted from end 172. Light detector 31a outputs a signal corresponding to the measured intensity to controller 14.

Light detector 31b measures the intensity of the second reflected light, which has entered from end 181, been guided along optical fiber 18, and been emitted from end 182. Light detector 31b outputs a signal corresponding to the measured intensity to controller 14.

### Method for Controlling Relative Positions of Movable Component 11 and Movable Component 12

Next, a method for controlling the relative positions of movable component 11 and movable component 12 is described. The basic principles are the same as in Embodiment 1; thus, the description focuses on the components that have differences.

The distance from the principal point of condenser lens 126 to end 171 of optical fiber 17 is different from the distance from the principal point of condenser lens 126 to end 181 of optical fiber 18. The quantity of light that enters the interior of the optical fiber from the end of the optical fiber is greater as the end becomes closer to the light condensing position of condenser lens 126. The light condensing position of condenser lens 126 is dependent upon the relative positions of condenser lens 125 on the mirror 113 side, and mirror 113.

Thus, for example, controller 14 sends, to driving mechanism 13, the signal for moving movable component 12 such that the intensity of the first reflected light measured at light detector 31a is constantly at the maximum. Consequently, the relative positions of movable component 11 and movable component 12 can be kept constant by adjusting the position of movable component 12.

Alternatively, controller 14 may adjust the relative position of movable component 12 via driving mechanism 13 such that the difference between the intensity of the light measured by light detector 31a and the intensity of the light measured by light detector 31b is 0.

### Effects

Next, the effects of measurement device 2 according to the present embodiment are described while presenting a comparison to conventional optical probe 10x, illustrated in FIG. 6.

Specifically, in the conventional example, light detectors 31ax and 31bx, which are fixed to movable component 12x, are used for measurement of the relative positions of movable component 11x and movable component 12x. In contrast, in measurement device 2, end 171 of optical fiber 17 and end 181 of optical fiber 18 are adopted as light entry points 122a and 122b, respectively, and light detectors 31a and 31b are disposed outside of movable component 12. The advantages resulting from such a configuration are explained below.

Similarly to Embodiment 1, the first advantage is the reduction in size of movable component 12.

Similarly to the case of semiconductor laser 21x, it is also necessary for light detectors 31ax and 31bx to have diameters of about several mm in size for sealing. In contrast, in the present embodiment, light detectors 31a and 31b are disposed separately from movable component 12, and end 171 of optical fiber 17 and end 181 of optical fiber 18 are connected to movable component 12. Thus, similarly to Embodiment 1, movable component 12 can be reduced in size and weight. Furthermore, in the present embodiment, the light-shielding members having the pinholes can be omitted. Thus, further reduction in size and weight can be achieved.

The second advantage is the reduction of wires. This is also similar to Embodiment 1.

### Embodiment 3

Next, a measurement device according to Embodiment 3 is described. Compared to the measurement devices of Embodiments 1 and 2, the measurement device according to the present embodiment differs in the point that neither a light detector nor a laser element is provided to the movable components. In particular, in the present embodiment, the light entry point and the light emission point are each an end of the optical fiber.

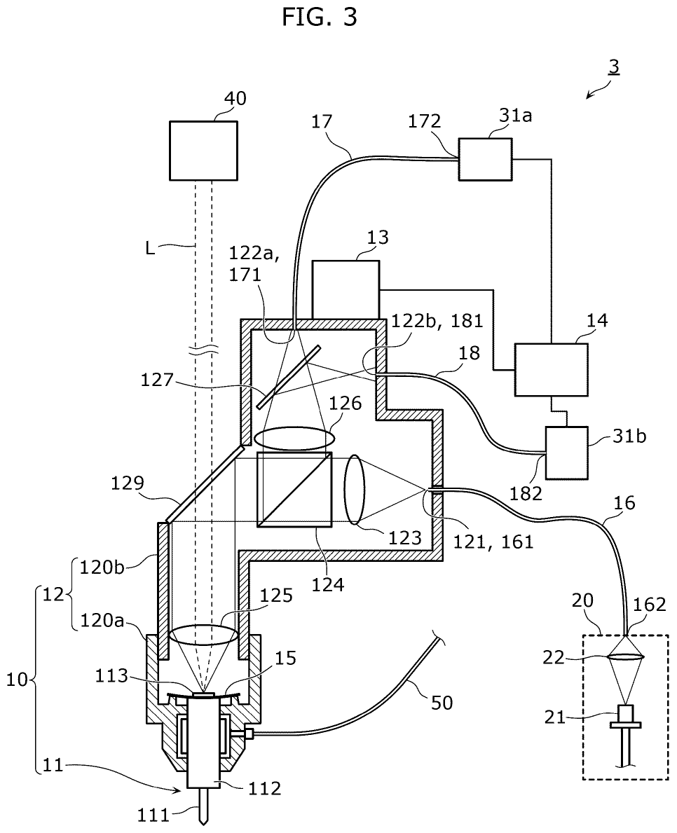

Hereinafter, the specific configuration of the measurement device according to the present embodiment is described with reference to FIG. 3. FIG. 3 illustrates an outline configuration of the measurement device according to the present embodiment. Note that hereinafter, detailed explanation of the components shared with Embodiment 1 or 2 is omitted or simplified, and the description focuses on the points of difference from Embodiment 1 or 2.

As illustrated in FIG. 3, compared to measurement device 2 according to Embodiment 2, measurement device 3 of the present embodiment differs in the point that measurement device 3 includes optical fiber 16 and light source component 20 instead of laser element 21. Optical fiber 16 and light source component 20 are the same as optical fiber 16 and light source component 20 included in measurement device 1 of Embodiment 1. In other words, measurement device 3 according to the present embodiment has a configuration in which measurement device 1, illustrated in FIG. 1, and measurement device 2, illustrated in FIG. 2, are combined.

Specifically, in measurement device 3, light emission point 121 is end 161 of optical fiber 16. Light entry points 122a and 122b are end 171 of optical fiber 17 and end 181 of optical fiber 18, respectively.

This obviates the need to provide movable component 12 with laser element 21 and light detectors 31a and 31b, and with light-shielding components 128a and 128b. It is unnecessary to provide movable component 12 with wiring for power lines or signal lines that connect to laser element 21 and light detectors 31a and 31b. Thus, further size reduction and weight reduction compared to the conventional configuration can be achieved. Furthermore, the first advantage and the fourth advantage described in Embodiments 1 and 2 can be attained.

### Embodiment 4

Next, a measurement device according to Embodiment 4 is described. The measurement device according to the present embodiment has a configuration in which a bundled fiber, involving a plurality of cores being bundled together, is connected to a movable component.

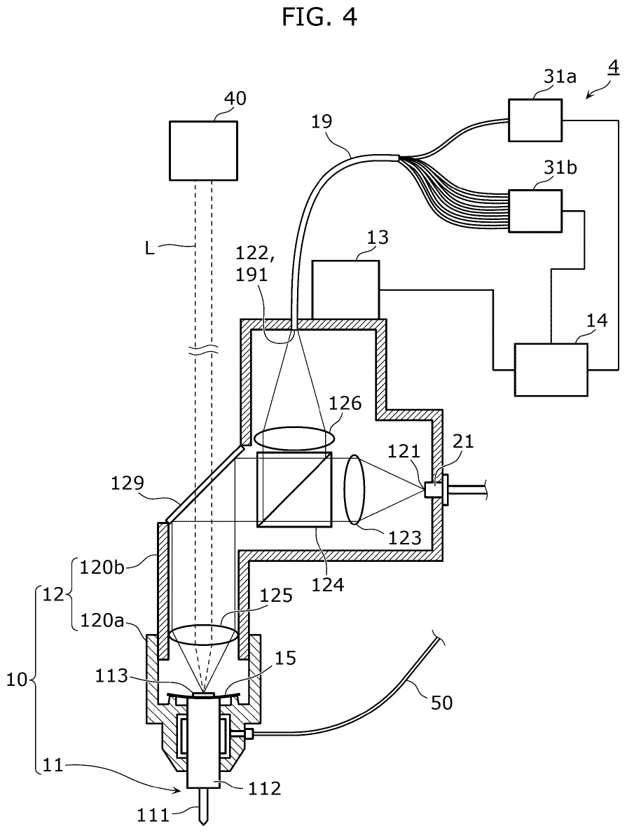

Hereinafter, the specific configuration of the measurement device according to the present embodiment is described with reference to FIG. 4. FIG. 4 illustrates an outline configuration of the measurement device according to the present embodiment. Note that hereinafter, detailed explanation of the components shared with Embodiment 1 and 2 is omitted or simplified, and the description focuses on the points of difference from Embodiment 1 or 2.

As illustrated in FIG. 4, measurement device 4 according to the present embodiment includes probe 10, driving mechanism 13, controller 14, spring 15, and bundled fiber 19. Furthermore, measurement device 4 includes laser element 21, light detectors 31a and 31b, and interferometer 40. Note that similarly to Embodiment 1 or 3, measurement device 4 may include optical fiber 16 and power source component 20 instead of laser element 21.

### Probe

Probe 10 includes movable component 11 and movable component 12. The configuration of movable component 11 is the same as in Embodiment 1; thus, explanation thereof is omitted.

Movable component 12 includes guide mechanism 120a and probe housing 120b. The configurations of guide mechanism 120a and probe housing 120b are the same as in Embodiment 1. Note that in accordance with, e.g., the elements provided to and the cable(s) connected to movable component 12, the shapes and sizes of guide mechanism 120a and probe housing 120b may be changed as appropriate.

Furthermore, movable component 12 has light emission point 121 and light entry point 122. Similarly to Embodiment 2, light emission point 121 is the laser emission face of laser element 21. In the present embodiment, the specific configuration of light entry point 122 is different from that in Embodiment 2. Specifically, light entry point 122 is end 191 of bundled fiber 19.

Movable component 12 has an optical system fixed to probe housing 120b. Compared to Embodiment 1, the optical system of the present embodiment differs in the point that beam splitter 127 is not included. Specifically, the optical system includes collimator lens 123, optical element 124, condenser lens 125, condenser lens 126, and optical element 129.

### Bundled Fiber

Bundled fiber 19 is an example of the optical fiber, and is a multi-core fiber that includes a plurality of cores. Each core of bundled fiber 19 can transmit respectively different light.

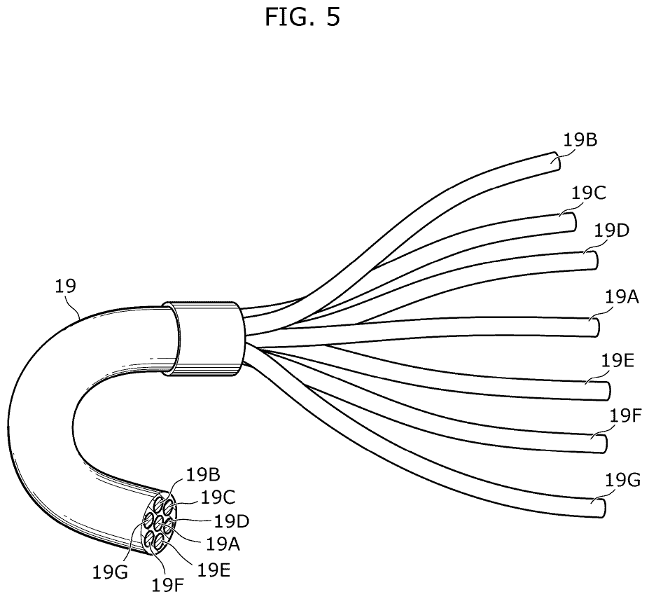

FIG. 5 illustrates the concept of the bundled fiber. Bundled fiber 19 illustrated in FIG. 5 includes the seven cores of 19A, 19B, 19C, 19D, 19E, 19F, and 19G. Note that the total number of cores is acceptable as long as it is a plurality, and is not particularly limited. For example, in bundled fiber 19, the plurality of cores are bundled at one end, and at the other end, at least one of the plurality of cores is separated. The end at which the plurality of cores are bundled makes it possible to dispose the cores in an area with narrow space. The end at which the plurality of cores are separated makes it possible to connect each of the cores to a separate light detector. Alternatively, the plurality of ends can be collectively connected to one light detector.

In the present embodiment, as illustrated in FIG. 4, end 191, at which the plurality of cores of bundled fiber 19 are bundled, is fixed near the light collection point of condenser lens 126 of probe housing 120b.

The end at which the cores of bundled fiber 19 are separated is connected to the light detectors without being fixed to movable component 12. A plurality of the cores can be connected to one light detector, without connecting all of the cores to separate light detectors. For example, core 19A is present at the center of end 191, which involves the seven cores of 19A, 19B, 19C, 19D, 19E, 19F, and 19G being bundled together; and the other end corresponding to core 19A is connected to light detector 31a. The ends corresponding to cores 19B, 19C, 19D, 19E, 19F, and 19G, present in the periphery of core 19A, are connected to light detector 31b.

### Light Detectors

In the present embodiment, at least two light detectors are provided. Specifically, as illustrated in FIG. 4, light detectors 31a and 31b each measure the intensity of light that has been transmitted by separate cores of bundled fiber 19. More specifically, light detector 31a measures the intensity of the reflected light that has entered core 19A, which is at the center of end 191 of bundled fiber 19. Light detector 31b measures the total intensity of the reflected light that has entered each of the six cores of 19B, 19C, 19D, 19E, 19F, and 19G, which are in the periphery of end 191 of bundled fiber 19.

### Method for Controlling Relative Positions of Movable Component 11 and Movable Component 12

Next, a method for controlling the relative positions of movable component 11 and movable component 12 is described.

In the flat surface where end 191 of bundled fiber 19 is present, the cross-sectional distribution of light intensity created by condenser lens 126 differs in accordance with the light condensing position of condenser lens 126. Specifically, being closer to the light condensing position of condenser lens 126 leads to the light intensity becoming more concentrated toward the center, resulting in a distribution with attenuation in the peripheral part. The light condensing position of condenser lens 126 is dependent upon the relative positions of condenser lens 125 on the mirror 113 side, and mirror 113.

Therefore, the extent to which the light condensing position is near end 191 of bundled fiber 19 can be ascertained by comparing, in end 191 of bundled fiber 19: the intensity of light that has entered core 19A, which is in the center; and the intensity of light that has entered at least one of cores 19B, 19C, 19D, 19E, 19F, and 19G, which are in the peripheral part.

For example, when the position of movable component 12 has slightly shifted due to controlling driving mechanism 13, it can be ascertained that the light condensing position has approached end 191 of bundled fiber 19 if there is an increase in the light intensity ratio of: the intensity of light that has entered core 19A, which is in the center; to the intensity of light that has entered cores 19B, 19C, 19D, 19E, 19F, and 19G, which are in the peripheral part. Conversely, if the light intensity ratio decreases, it can be ascertained that the light condensing position has moved away from end 191 of bundled fiber 19.

The position at which condenser lens 126 maximally condenses light is dependent upon the relative positions of movable component 11 and movable component 12. Thus, by ascertaining the ratio of the quantity of light that enters each core, controller 14 can calculate the relative positions of movable component 11 and movable component 12. Controller 14 calculates both the movement position and the movement distance of movable component 12 such that the relative calculated positions approach the specified value. Furthermore, by sending a control signal to driving mechanism 13, controller 14 can adjust the position of movable component 12 by means of driving mechanism 13.

The advantage of the present embodiment is that there is one end of the optical fiber to be fixed to movable component 12. Thus, the advantage lies in the fact that movable component 12 can be reduced in size and weight. Note that in a configuration in which a plurality of cores are present in the peripheral part, information regarding the inclination of mirror 113 can be obtained by connecting an independent light detector to each core.

Note that similarly to Embodiment 1 or 3, measurement device 4 according to the present embodiment may include power source component 20 and optical fiber 16 instead of laser element 21. Consequently, the first advantage and the fourth advantage described in Embodiment 1 can be attained.

Furthermore, bundled fiber 19 may be utilized as an optical fiber for allowing light to enter the interior of movable component 12. For example, central core 19A may be used not only for guiding reflected light, but also for guiding light from laser element 21. In this case, end 191 of bundled fiber 19 is light emission point 121, and also light entry point 122. In other words, light emission point 121 and light entry point 122 may be the same.

In this case, the end of central core 19A on the side opposite to end 191 is connected to an optical element that controls the traveling direction of light, such as a circulator or the like. Thus, light from laser element 21 can be made to enter core 19A and be emitted from end 191, and the reflected light that enters from end 191 can be guided along core 19A and then directed to light detector 31a.

### Other Embodiments

The measurement device according to one or a plurality of aspects has been described based on the embodiments, but the present disclosure is not limited to these embodiments. Forms obtained by making various modifications to the above embodiments that can be conceived by those skilled in the art, as well as forms obtained by combining constituent elements in different embodiments, without materially departing from the spirit of the present disclosure, are thus included in the scope of the present disclosure.

For example, in the measurement device according to each of the exemplary embodiments, movable component 11 and movable component 12 may be completely uncoupled. The relative positions of movable component 11 and movable component 12 in the up-down direction may be variable by means of the weight of movable component 11 itself. In this case, the weight of movable component 11 itself can be effectively utilized by adjusting the orientation of the measurement device such that the up-down direction matches the vertical direction. Note that a regulator such as a projection that regulates the position of movable component 11 may be provided so that movable component 11 does not detach from movable component 12.

Furthermore, the present disclosure may be realized as a control system for, or a method for controlling a movable body included in a measurement device. The control system is, for example, realized by means of one or more computer devices. Specifically, the control system includes a controller that controls a driving mechanism, which adjusts the position of a second movable body having a light emission point, a light entry point, and an optical system. The light emission point or the light entry point is an end of at least one optical fiber. Light emitted from the light emission point is emitted onto a reflector included in a first movable body, and reflected light reflected from the reflector enters the light entry point. The controller causes the driving mechanism to adjust the position of the second movable body, based on the intensity of the reflected light that has entered the light entry point.

Furthermore, the present disclosure may be realized as a non-contact-type measurement device. Specifically, a first movable body of the measurement device may not come into contact with a measurement target when measuring the measurement target. For example, an interferometer may be configured such that light is emitted onto the surface of the measurement target and reflected light, being the light from the measurement target, is received.

Note that the one or more computer devices include, for example: nonvolatile memory in which program(s) are stored; volatile memory that is a temporary storage area for executing program(s); input/output port(s); a processor for executing program(s); and the like. Furthermore, the control system may be an FPGA (field-programmable gate array) that allows for programming or a reconfigurable processor in which connection and settings of circuit cells in an LSI can be reconfigured. The functions executed by the control system may be executed by means of software, or may be executed by means of hardware.

Furthermore, the method for controlling the movable body included in the measurement device includes a step of controlling a driving mechanism, which adjusts the position of a second movable body having a light emission point, a light entry point, and an optical system. The light emission point or the light entry point is an end of at least one optical fiber. Light emitted from the light emission point is emitted, via the optical system, onto a reflector included in a first movable body, and reflected light reflected from the reflector enters the light entry point. In the controlling step, the position of the second movable body is adjusted by controlling the driving mechanism based on the intensity of the reflected light that has entered the light entry point.

Furthermore, the present disclosure may be realized as a program for causing a computer to execute the method for controlling the movable body included in the measurement device. Furthermore, the present disclosure may be realized as a non-transitory recording medium that stores the program.

Furthermore, various modifications, replacement, addition, and omission may be carried out on each of the foregoing exemplary embodiments within the scope of the claims or its equivalents.

### Industrial Applicability

The present disclosure can be used in various measurement devices for, e.g., testing of industrial products that necessitate highly accurate distance measurement.

1. A measurement device comprising:
a first movable body including a reflector;
a second movable body including a light emission point, a light entry point, and an optical system;
a driving mechanism that adjusts a position of the second movable body;
a controller that controls the driving mechanism; and
at least one optical fiber, wherein
light emitted from the light emission point is emitted onto the reflector via the optical system,
reflected light that is the light reflected from the reflector enters the light entry point,
the controller causes the driving mechanism to adjust the position of the second movable body, based on an intensity of the reflected light that has entered the light entry point, and
the light emission point or the light entry point is an end of the at least one optical fiber.

2. The measurement device according to claim 1, wherein
when the measurement device measures a target, the first movable body comes in contact with the target.

3. The measurement device according to claim 1, comprising:
an elastic body that couples the first movable body with the second movable body.

4. The measurement device according to claim 1, wherein
the at least one optical fiber includes a first optical fiber,
the light emission point is a first end of the first optical fiber,
the second movable body includes:
a beam splitter that splits the reflected light into first reflected light and second reflected light;
a first light-shielding member including a first pinhole that the first reflected light enters; and
a second light-shielding member including a second pinhole that the second reflected light enters,
the second movable body includes a plurality of light entry points each being the light entry point, and
each of the first pinhole and the second pinhole is the light entry point.

5. The measurement device according to claim 1, wherein
the second movable body includes:
a laser element including the light emission point; and
a beam splitter that splits the reflected light into first reflected light and second reflected light,
the at least one optical fiber includes:
a second optical fiber including a second end that the first reflected light enters; and
a third optical fiber including a third end that the second reflected light enters,
the second movable body includes a plurality of light entry points each being the light entry point, and
each of the second end and the third end is the light entry point.

6. The measurement device according to claim 1, wherein
the second movable body includes a beam splitter that splits the reflected light into first reflected light and second reflected light,
the at least one optical fiber includes:
a first optical fiber;
a second optical fiber including a second end that the first reflected light enters; and
a third optical fiber including a third end that the second reflected light enters,
the light emission point is a first end of the first optical fiber,
the second movable body includes a plurality of light entry points each being the light entry point, and
each of the second end and the third end is the light entry point.

7. The measurement device according to claim 1, wherein
the at least one optical fiber includes a multi-core fiber including a plurality of cores,
the second movable body includes a plurality of light entry points each being the light entry point, and
individual ends of the plurality of cores are each the light entry point.

8. The measurement device according to claim 1, wherein
the at least one optical fiber is a single-mode fiber.

9. The measurement device according to claim 1, wherein
the at least one optical fiber is a multi-mode fiber.

10. The measurement device according to claim 1, wherein
the optical system includes a graded-index lens that is fixed to the end of the at least one optical fiber.

11. The measurement device according to claim 1, wherein
the at least one optical fiber includes a multi-core fiber including a plurality of cores, and
an end of one of the plurality of cores is the light entry point and the light emission point.

12. The measurement device according to claim 4, comprising:
a laser element, wherein
light emitted from the laser element enters from an end of the first optical fiber on a side opposite to the first end, is guided along the first optical fiber, and is emitted from the first end.

13. The measurement device according to claim 1, comprising:
a light intensity measurer that measures an intensity of the reflected light that has entered the light entry point.
